(19) United States
(12) Patent Application Publication
(10) Pub. No.: US 2006/0004604 A1
(43) Pub. Date: Jan. 5, 2006

(54) Method and system for providing a service to a person

(76) Inventor: Martin Allan White, Saint Louis, MO (US)

Correspondence Address: Joseph E. Zahner, 3646 Dover Place, Saint Louis, MO, 63116, US

(21) Appl. No.: 10/885,290

(22) Filed: Jul. 2, 2004

(51) Int. Cl. G06Q 50/00; G06Q 40/00

(52) U.S. Cl. 705/2; 705/40; 705/32

(57) ABSTRACT

A method and system for managing information related to providing health care services, which includes recording on a portable electronic device a time at which the service begins to be provided, retrieving from a person to which the service is provided a first identifier corresponding to the person, associating the retrieved first identifier with the recorded time when the service begins to verify when service began to be provided, recording a time when the service ends, retrieving from the person a second identifier corresponding to the person, associating the retrieved second identifier with the recorded time when the service ends to verify when service ended, and uploading electronic forms from the portable electronic device to a remote or connected processor.

### BACKGROUND OF THE INVENTION

1. Field of the Invention

The present invention relates generally to managing information, and more specifically to managing information related to providing a medical-insurance based service to a person.

2. Description of the Related Art

Many service agencies provide services to people at their homes or residences (sometimes referred to as in-home services). Some such agencies provide in-home medical-insurance based services. For example, many agencies (often referred to as in-home service providers) provide in-home health care and related services to patients under Medicaid. Medicaid typically awards patients with a monthly allotment of hours for a variety of categories and sub-categories of services. Once the in-home service provider has received a monthly allotment of hours for a patient, the provider schedules a worker to provide the service(s). Scheduling is typically done manually using a paper calendar, a copy of which the worker takes to the patient's residence. However, manual scheduling may be time consuming and difficult, and may require multiple employees to schedule services for each of the provider's patients.

Once the scheduling is complete, a worker visits a patient's residence to provide the service(s). The worker typically documents the visit by manually filling out a weekly paper timesheet. Under the Health Insurance Portability and Accountability Act of 1996 (HIPAA), for each service provided Medicaid currently requires the timesheet include a description of the type of service, the duration of the service, the date the service was performed, and the patient's signature for each day a service was provided. If an entry in the timesheet is completed incorrectly, the worker must return to the patient's residence to have the patient re-sign the corrected entry. Medicaid sometimes randomly audits these time sheets and may require the in-home service provider keep the timesheets on file for up to 5 years. Accordingly, the provider may need a large amount of storage space to store the paper timesheets. Also, because the timesheets are generally written by hand, mistakes and/or illegible entries can be common. If a timesheet is not filed and/or filled out correctly, Medicaid may fine the in-home service provider. Accordingly, the provider may have to thoroughly double-check each timesheet to ensure they are correct and have the necessary signatures of the patient. Additionally, if for any reason the patient receives more than the allotted number of hours for a particular category and/or sub-category of service, often referred to as over-servicing or upcoding, the in-home service provider may not be reimbursed from Medicaid for the time over the allotted amount but may still have to pay a worker who provided the service for the overtime.

The weekly timesheets may also be used by the provider to generate payroll information. For example, the timesheets may be used to determine how many hours a worker will be paid for. However, generating payroll information from the paper timesheets can be time consuming and may require more than one employee to sort through all of the timesheet data. After the timesheets have been completed by the worker, they are processed for billing Medicaid for the service(s) provided. Currently, data from the timesheets may be submitted to Medicaid either on a website provided by Medicaid or on software configured to batch bill Medicaid. Entering the timesheet data into the website or software can be time consuming and therefore costly. Also, depending on the size of the provider such billing may require multiple employees, further increasing costs expended by the provider. Some providers hire third parties to process the timesheets for billing Medicaid. However, hiring such third parties can be costly. For example, some such third parties may charge up to and greater than about six percent of Medicaid's reimbursement to the provider for the month billed.

### SUMMARY OF THE INVENTION

In one aspect, a method is provided for providing a service to a person. The method includes recording a time at which the service begins to be provided, retrieving from the person a first identifier corresponding to the person, associating the retrieved first identifier with the recorded time when the service begins to verify when service began to be provided, recording a time when the service ends, retrieving from the person a second identifier corresponding to the person, and associating the retrieved second identifier with the recorded time when the service ends to verify when service ended.

In another aspect, a method is provided for providing a service to a person. The method includes, when service begins, retrieving from the person a first identifier corresponding to the person, recording a time when the first identifier is retrieved from the person, storing the retrieved first identifier and the recorded time when the first identifier is retrieved as electronic data for verification of when service began. The method also includes, when service ends, retrieving from the person a second identifier corresponding to the person, recording a time when the second identifier is retrieved from the person, and storing the retrieved second identifier and the recorded time when the second identifier is retrieved as electronic data for verification of when service ended.

In yet another aspect, the present invention includes a portable electronic device for providing a service to a person. The device includes a processor and a plurality of sequences of executable instructions configuring the processor to retrieve from the person a first identifier corresponding to the person when service begins, record a time when the first identifier is retrieved from the person, store the retrieved first identifier and the recorded time when the first identifier is retrieved as electronic data for verification of when service began, retrieve from the person a second identifier corresponding to the person when service ends, record a time when the second identifier is retrieved from the person, and store the retrieved second identifier and the recorded time when the second identifier is retrieved as electronic data for verification of when service ended.

In even another aspect, a method is provided for providing a service to a person. The method includes storing service information as electronic data within a portable device, wherein the service information comprises at least one of a description of the service, a duration of the service, and a date of the service, uploading the service information from the portable electronic device to a processor, creating an electronic file compliant with a government privacy standard and comprising the service information using the processor, and billing an entity for the service by submitting the electronic file created by the processor to the entity. In yet another embodiment, the invention is directed to a method of managing information related to a Medicaid-based service provided to a person. The method includes storing a description of the provided service as electronic data within a portable electronic device, storing a duration of the provided service as electronic data within the portable electronic device, storing a date of the provided service as electronic data within the portable electronic device, obtaining a personal identifier from the person, uploading the description of the provided service, the duration of the provided service, and the date of the provided service from the portable electronic device to a first processor, creating an electronic file compliant with a government privacy standard and comprising the description of the provided service, the duration of the provided service, and the date of the provided service using the first processor; and billing Medicaid for the service provided by submitting the electronic file created by the first processor to Medicaid. The first processor may be a server, desk top computer, notebook, tablet PC, handheld computer, personal digital assistant and the like. The personal identifier may be a signature, an electronic signature, a fingerprint, eye image data, a voice print, a facial pattern, a hand measurement, and the like.

Other features of the present invention will be in part apparent and in part pointed out hereinafter.

### BRIEF DESCRIPTION OF THE DRAWINGS

FIG. 1 is a schematic of a system for providing a service to a person;

FIG. 2 is a flowchart illustrating one embodiment of the present invention of a method for providing a service to a person;

FIG. 3 is a flowchart illustrating a second embodiment of the present invention of a method for the providing a service to a person;

FIG. 4 is a flowchart illustrating a third embodiment of the present invention of a method for providing a service to a person;

FIG. 5 is a flowchart illustrating a fourth embodiment of the present invention of a method for providing a service to a person;

FIG. 6 is an exemplary screen shot for storing personal information;

FIG. 7 is an exemplary screen shot for storing worker information;

FIG. 8 is an exemplary screen shot for scheduling service(s); and

FIG. 9 is an exemplary screen shot resembling the Medicaid Weekly Time Sheets for inputting/selecting service information.

Corresponding reference characters indicate corresponding parts throughout the several views of the drawings.

### DETAILED DESCRIPTION OF THE PREFERRED EMBODIMENT

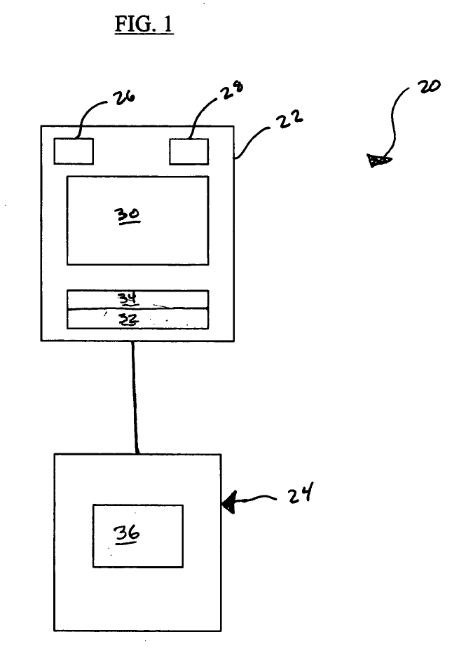

Referring now to the drawings, and more specifically to FIG. 1, a system for providing a service to a person is designated in its entirety by the reference numeral 20. The system 20 includes a portable electronic device 22 and a processor (generally designated by 24) operably connectable to the portable electronic device. The portable electronic device 22 includes a processor 26 and may also include a memory 28, a display 30 for displaying text and/or images, a biometric reader 32, and a user interface 34 (e.g., a keypad, a mouse, a trackball, and the like) for inputting and/or selecting text and other information into the device for storage by the memory 28, processing by the processor 26, and/or exchange with another electronic device (e.g., the processor 24). The biometric reader 32 receives biometric data from the person and converts the biometric data into digital form for use by the portable electronic device 22, the processor 24, and/or another electronic device as an identifier corresponding to the person. Although other biometric data may be retrieved and converted into an identifier by the reader 32 without departing from the scope of the present invention, in one embodiment the identifier includes digital electronic signature data, fingerprint image data, eye image data, a voice print, a facial pattern, and/or a hand measurement. The biometric reader 32 may be an integral component of the display 30 and/or the user interface 34, or alternatively the biometric reader may be operably connectable to the display and/or the user interface for receiving biometric data from the display and/or the user interface. Although other portable electronic devices, such as tablet-type PCs, lap top computers, notebooks, and the like, may be used without departing from the scope of the present invention, in one embodiment the portable electronic device 22 is a Personal Digital Assistant (PDA), for example a Palm™ V available from palmOne, Inc. of Milpitas, Calif.

The processor 24 is operably connectable to the portable electronic device 22 for, among other things, exchanging information with the device. The processor 24 may be operably connectable to the device 22 in any suitable manner facilitating the exchange of information as electronic data between the device and the processor 24. For example, in one embodiment the processor 24 is physically connectable to the device 22, for example using cables (not shown) and/or a docking station (not shown). In another embodiment, the processor 24 is operably connectable to the device 22 through a network, such as a wide area network (WAN, e.g., the Internet) and/or a local area network (LAN, e.g., an intranet). The processor 24 may also include a memory 36 for storing information as electronic data. Although other processors may be used without departing from the scope of the present invention, in one embodiment the processor 24 is selected from a group consisting of a server, a desktop computer, a notebook computer, a tablet personal computer (PC), a handheld computer, or any combination thereof. Either of the processor 24 and the processor 26 are referred to herein as a first and a second processor, respectively.

Both the portable electronic device 22 and the processor 24 may include a plurality of executable instructions (not shown) stored therein (e.g., using the respective memories 30, 36) for performing the methods of the present invention set forth herein.

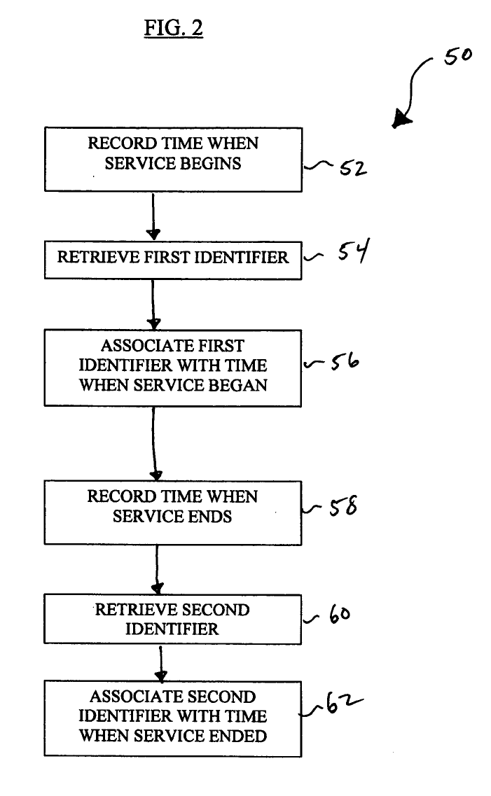

As illustrated in FIG. 2, a method of the present invention for providing a service to a person is designated in its entirety by the reference numeral 50. The method 50 includes recording 52 a time at which the service begins to be provided, retrieving 54 from the person a first identifier corresponding to the person, and associating 56 the retrieved first identifier with the recorded time when the service begins to verify when service began. The method 50 additionally includes recording 58 a time when the service ends, retrieving 60 from the person a second identifier corresponding to the person, and associating 62 the retrieved second identifier with the recorded time when the service ends to verify when service ended. In one embodiment, at least one of the retrieved first and second identifiers include biometric data converted into digital form, such as digital electronic signature data, fingerprint image data, eye image data, a voice print, a facial pattern, and/or a hand measurement, as discussed above with regard to the system 20 (FIG. 1). In another embodiment, at least one of the retrieved first and second identifiers include information that is not converted into digital form. Although other non-digital information may be used as the first and/or the second identifier without departing from the scope of the present invention, in one embodiment the first and/or second identifier is selected from a group consisting of a handwritten signature or other handwritten symbol corresponding to the person, a copy of a driver's license, a copy of a picture identification, a fingerprint, a palm print, and a picture or likeness of the person.

The method 50 may be used to verify when the service began and when the service ended. Accordingly, a duration of the service can be accurately recorded and verified by the person receiving the service and/or an entity responsible for payment of the service such that the person themselves and/or the entity is accurately billed for the proper duration of the service. For example, for medical insurance-based services (e.g., services provided under Medicaid) a patient is typically awarded with a monthly allotment of hours for a variety of categories and sub-categories of services. If for any reason the patient receives more than the allotted number of hours for a particular category and/or sub-category of service, often referred to as over-servicing or upcoding, an in-home service provider that provided the service may not be reimbursed from Medicaid for the time over the allotted amount. However, the in-home service provider may still have to pay a worker who provided the service for the overtime. The method 50 facilitates preventing such over-servicing or upcoding by verifying the accuracy of the recorded beginning and ending times through retrieval of the person's first and second identifiers and association of the identifiers with the recorded beginning and ending times.

The first and/or second identifier may be retrieved at any time before, during, or after the service has been provided. Accordingly, although the first and the second identifiers are associated with the time the service began and the time the service ended, respectively, the first and/or the second identifier need not be retrieved at the respective beginning and ended times. To ensure the beginning and ending times of service are accurately recorded, the person may be asked to verify the beginning and ending times are correct before submitting the first and/or the second identifier. Also, in one embodiment the person may be asked to submit the first and/or the second identifier adjacent to a location where the respective beginning and ending times are displayed and/or printed to accurately record the beginning and ending times by the person.

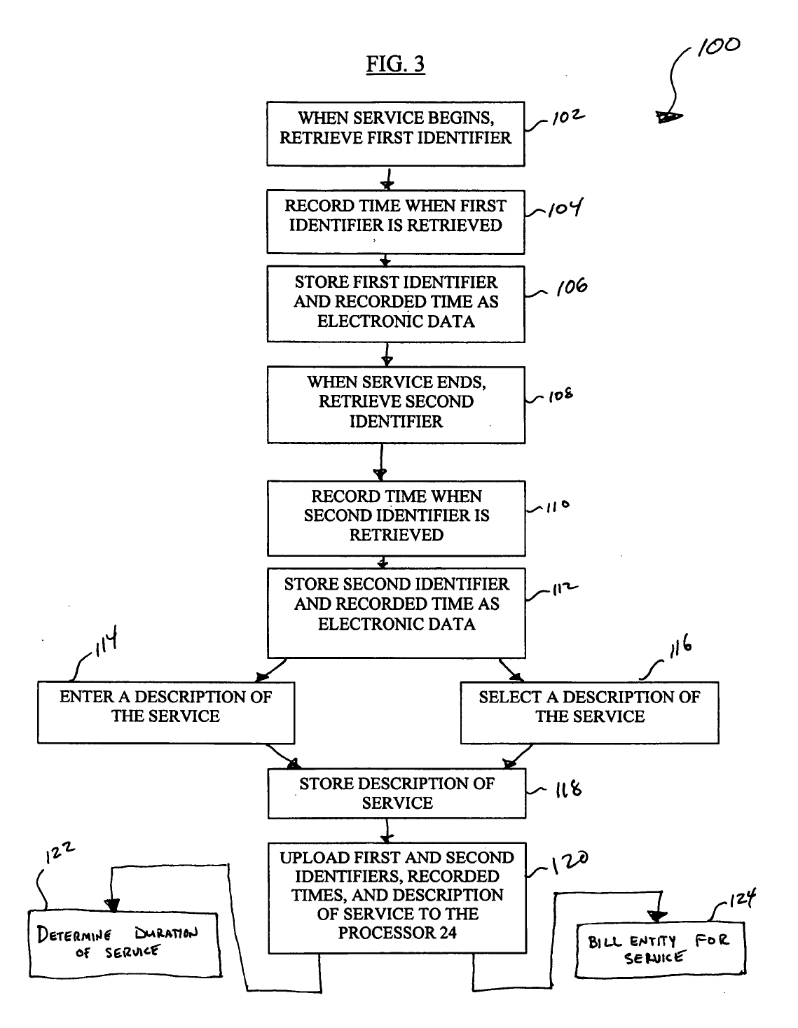

The method 50 may be performed manually using a paper-based, or similar, system including handwritten and/or printed information. Alternatively, the method 50 may be performed using the system 20 (FIG. 1) described above. For example, as illustrated in FIG. 3 a method (designated in its entirety by the reference numeral 100) similar to method 50 is performed using the system 20. The method 100 includes, when service begins, retrieving 102 from the person a first identifier corresponding to the person using the portable electronic device 22 (FIG. 1), and more specifically using the biometric reader 32 (FIG. 1). A time when the first identifier is retrieved from the person is recorded 104, and the first identifier and the recorded time when the first identifier is retrieved are stored 106 as electronic data for verification of when service began. The method 100 further includes, when service ends, retrieving 108 from the person a second identifier corresponding to the person using the portable electronic device 22, and more specifically using the biometric reader 32. A time when the second identifier is retrieved from the person is recorded 110, and the second identifier and the recorded time when the second identifier is retrieved are stored 112 as electronic data for verification of when service ended. The method 100 may also include entering 114 a description of the service into the portable electronic device 22 (e.g., using the user interface 34) and/or selecting 116 a description of the service from a plurality of descriptions stored in the device 22 (e.g., selecting from a plurality of descriptions displayed on display 30 (FIG. 1)) using the user interface or other means. The description of the service may then be stored 118 as electronic data within the device 22 (e.g., within the memory 30 (FIG. 1)).

As discussed above, the first and/or the second identifier may include biometric data converted into digital form, such as digital electronic signature data, fingerprint image data, eye image data, a voice print, a facial pattern, and/or a hand measurement. Additionally, although the first and second identifiers are retrieved when service begins and ends, respectively, such that the times when the first and the second identifiers are retrieved represent the respective beginning and end of service, in an alternative embodiment the first and second identifiers may be retrieved using the portable electronic device 22 at any time before, during, or after the service is provided. In such a case wherein the first and/or the second identifier is not retrieved at the respective beginning and end of service, the first and/or the second identifier may be merely associated with the respective beginning and ending time such that retrieval of the first and/or the second identifier from the person serves as verification that the beginning and ending times of the service are correct. Additionally, in such a case wherein the first and/or the second identifier is not retrieved at the respective beginning and end of service, the person and/or a worker providing the service may enter the beginning and/or ending time of the service into the portable electronic device using the user interface 34.

The retrieved first and second identifiers, the recorded times when the first and second identifier are retrieved, and if present the description of the service are stored as electronic using the portable electronic device 22, and may then be uploaded 120 to the processor 24 (FIG. 1) for use by the processor for storage, billing, generating payroll information, and any other activity. For example, the processor 24 may determine 122 a duration of the service using the recorded time when the first identifier is retrieved and the recorded time when the second identifier is retrieved. The processor 24 may also bill 124 an entity for the service by submitting to the entity as electronic data the determined duration of the service and a description of the service. Alternatively, the retrieved first and second identifiers, the recorded times when the first and second identifier are retrieved, and/or the description of the service may not be uploaded to the processor 24 but instead remain stored as electronic data using the portable electronic device 22 for use by the device for storage, billing, generating payroll information, and any other activity.

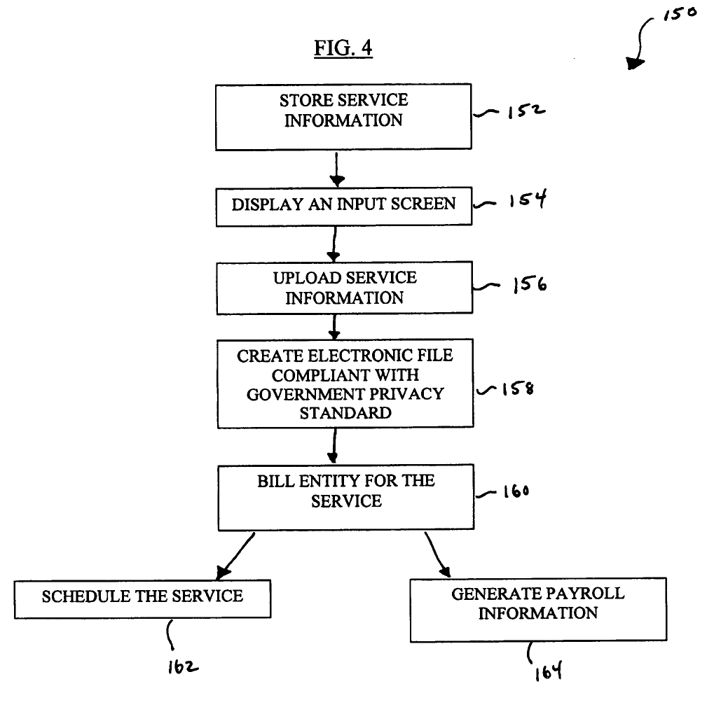

FIG. 4 illustrates another embodiment of a method of the present invention for providing a service to a person designated in its entirety with the reference numeral 150. The method 150 may be performed using the system 20 (FIG. 1). Specifically, the method 150 includes storing 152 service information as electronic data within the portable electronic device 22 (FIG. 1). The service information may be any information relating to the service. In one embodiment, the service information includes at least one of a description of the service, a duration of the service, and a date of the service. Additionally, the service information may include an identifier corresponding to the person receiving the service. The identifier may be any identifier that corresponds to the person receiving the service (e.g., at least one of the first identifier and the second identifier discussed above). The service information may be entered into the portable electronic device 22 by a worker providing a service and/or the person receiving the service using the user interface 34 (FIG. 1). Alternatively, the service information may be selected from service information stored in the device 22 (e.g., selecting from service information displayed on display 30 (FIG. 1)) by a worker providing the service and/or the person receiving the service. In one embodiment, the method 150 includes displaying 154 an input screen on the display 30 of the portable electronic device 22 for entering the service information. The service information is uploaded 156 from the portable electronic device 22 to the processor 24 (FIG. 1). The processor 24 creates 158 an electronic file that is compliant with a government privacy standard and includes the service information. The electronic file that is compliant with a government privacy standard may include service information for a plurality of services provided to the person over a period of time, and/or may include service information for at least one service provided to the person and at least one service provided to another person over a period of time. An entity is then billed 160 for the service by submitting the electronic file created by the processor 24 to the entity.

Although the electronic file may be compliant with any government privacy standard without departing from the scope of the present invention, in one embodiment the electronic file is created to be compliant with a government privacy standard selected from a group of standards consisting of the Health Insurance Portability and Accountability Act, the National Electronic Data Interchange Transaction Set Implementation Guide for ANSI ASC X12N 837 Health Care claims, other federal, state and international Privacy Standards, such as Missouri Stautes 191.656, 192.067, 210.115, 210.135, 210.140, 431, 431.060, 431.062, 431.064, 565.188, and the Illinois Public Health statute 410, Act 50—The Medical Patient Rights Act.

In an alternative embodiment, the service information is not uploaded 156 to the processor 24 but rather the portable electronic device 22 creates 158 the electronic file that is compliant with a government privacy standard and that includes the service information. The electronic file compliant with a government privacy standard may be submitted to the entity for billing in any suitable manner, for example by mailing, shipping, and/or delivering the electronic file to the entity. Alternatively, the electronic file compliant with a government privacy standard may be electronically submitted to the entity, for example using a WAN (e.g., the Internet) and/or a LAN (e.g., an intranet). In such a case wherein the electronic file compliant with a government privacy standard is electronically submitted to the entity, it may be submitted from the processor 24, the portable electronic device 22, or any other device having the file stored therein. In one embodiment, the electronic file compliant with a government standard is electronically submitted to the entity over the Internet to an internet site.

The method 150 may also include scheduling 162 the service using the processor 24 and downloading the schedule to the portable electronic device 22 for use by a worker that will be providing the service. Furthermore, the method 150 may include electronically generating 164 payroll information using the service information and at least one of the processor 24 and the portable electronic device 22.

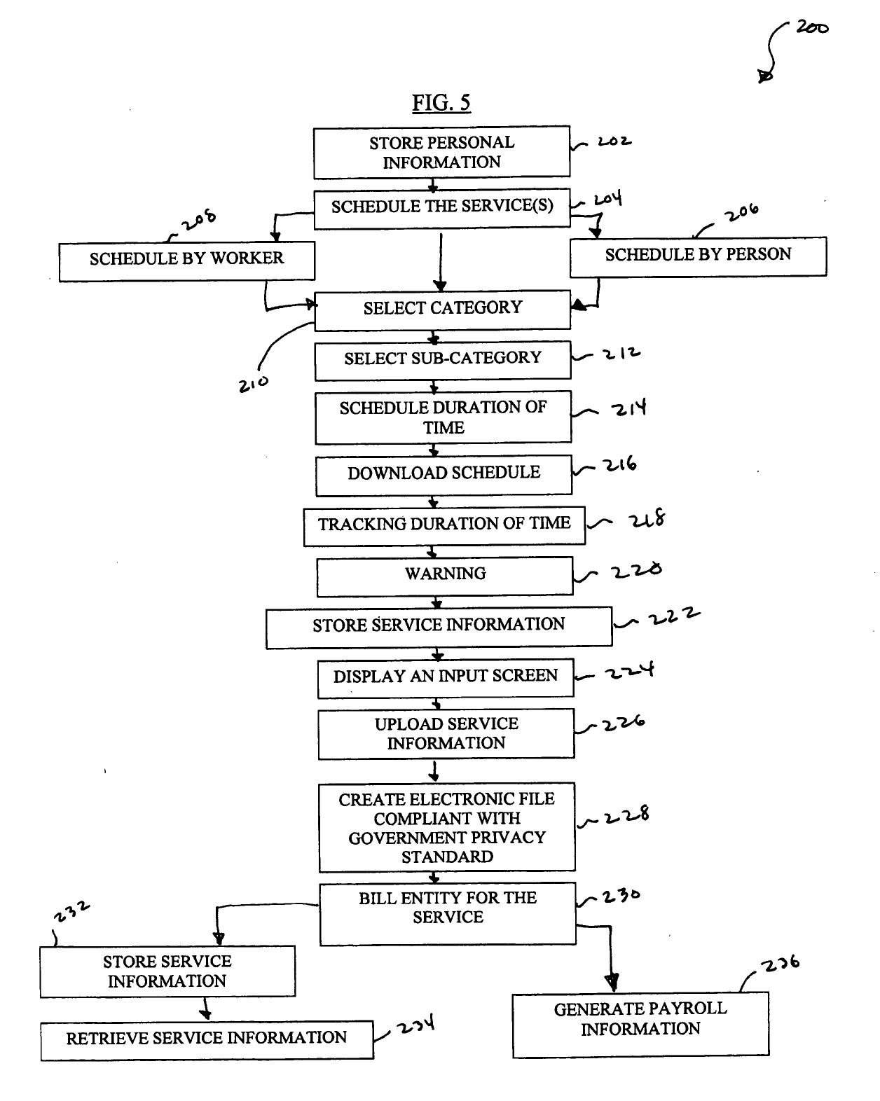

With regard to the methods and systems described herein, the entity may be any entity, and the service provided to the person may be any service. However, an exemplary method (designated in its entirety with the reference numeral 200) similar to the method 150 is illustrated in FIG. 5 with reference to the provision of a medical insurance-based service wherein the entity is a medical insurance-based entity. Specifically, in the exemplary embodiment of the method 200 illustrated in FIG. 5, the entity is Medicaid. Additionally, although the electronic file may be compliant with any government privacy standard without departing from the scope of the present invention, for the specific example of Medicaid the government privacy standard is selected to include the Health Insurance Portability and Accountability Act, and more specifically the National Electronic Data Interchange Transaction Set Implementation Guide for ANSI ASC X12N 837 Health Care claims.

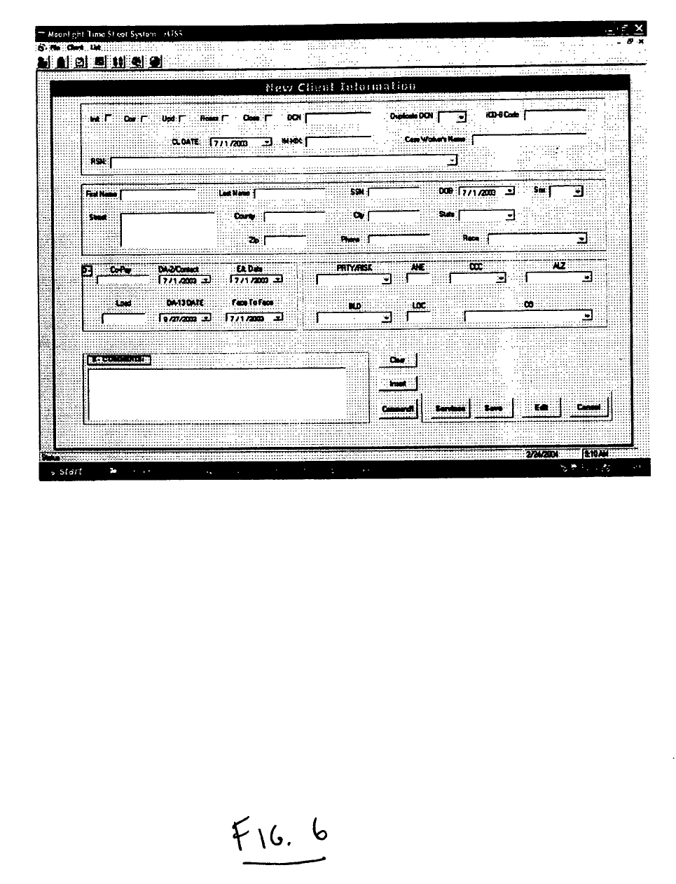

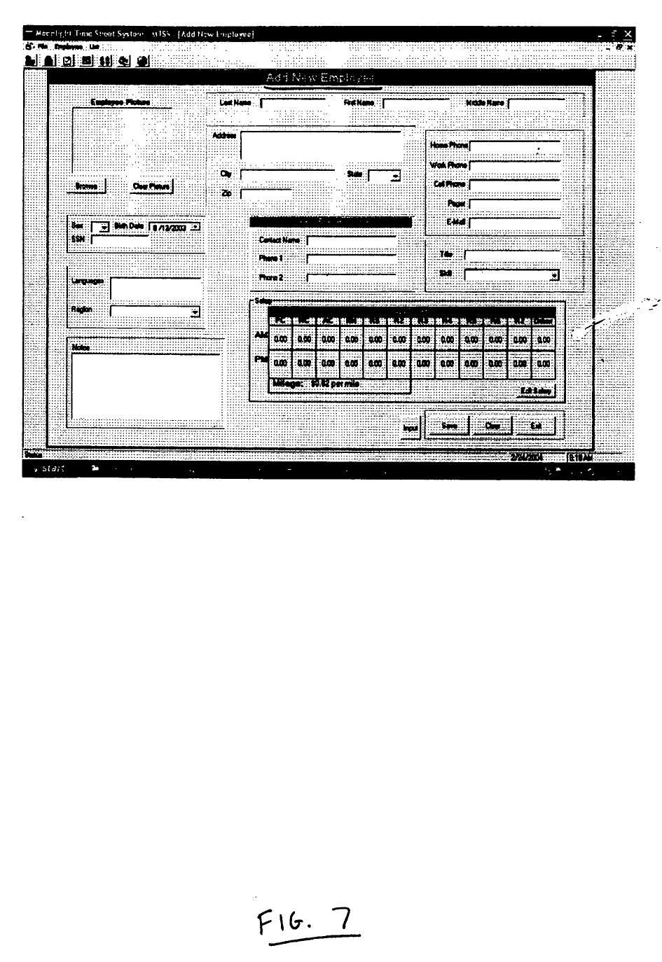

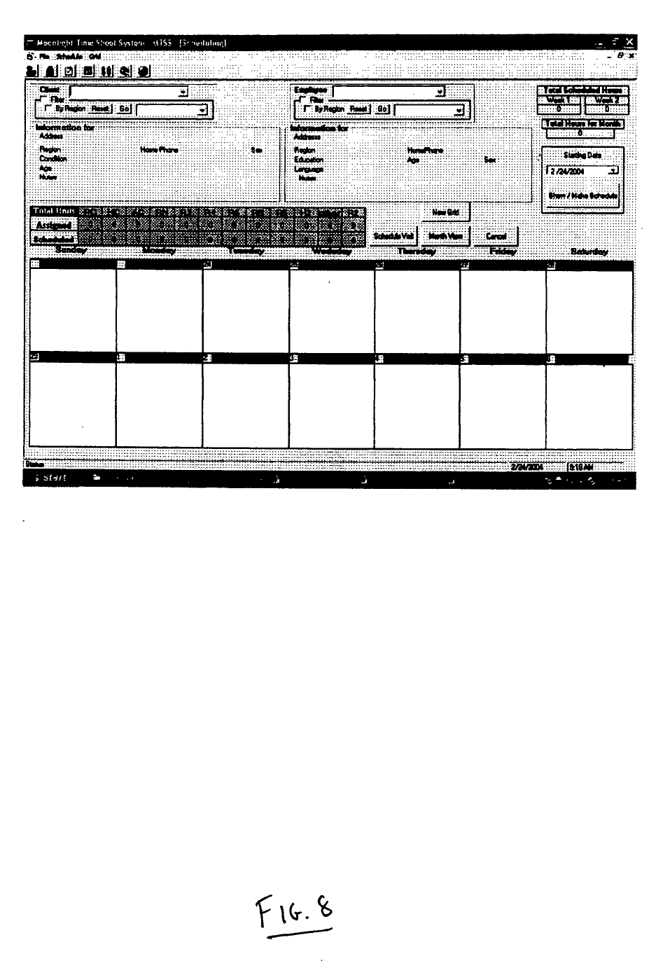

Currently, when Medicaid awards service to a person, an entity that will be providing the service receives information about the person (“personal information”) including what categories and sub-categories of service the person has been awarded and how many hours of each service the person will receive over a period of time (e.g., a month). The method 200 includes storing 202 the personal information (of one or more persons who have been awarded service) using the processor 24 (FIG. 1). (FIG. 6 illustrates an exemplary screen shot for storing personal information.) Additionally, information about at least one worker (“worker information”) who provides the service(s) on behalf for the entity may also be stored using the processor 24. (FIG. 7 illustrates an exemplary screen shot for storing worker information.) In an alternative embodiment, the personal information and/or the worker information is stored using the portable electronic device 22 (FIG. 1). Once the personal information and worker information are stored, the method 200 includes scheduling 204 the service using the processor 24. (FIG. 8 illustrates an exemplary screen shot for scheduling service(s).) Scheduling 204 the service may include scheduling 206 a plurality of services to be provided to the person over a period of time by a worker or a plurality of workers, and/or scheduling 204 the service may include scheduling 208 at least one service to be provided to the person by a worker and at least one service to be provided to another person by the worker. Accordingly, a schedule can be created for each worker on the basis of the service(s) provided to one or more persons by the worker over a period of time (e.g., a month), and/or a schedule can be created for each person on the basis of the service(s) provided to the person by one or more workers over a period of time (e.g., a month).

Scheduling 204 the service(s) may include selecting 210 at least one description for each scheduled service from a group of categories consisting of basic personal care, advanced personal care, respite, advanced respite, homemaker chore, authorized nurse visits, adult day heath care, telephone reassurance, and other. Additionally, scheduling the service(s) may include selecting 212 at least one sub-description for each scheduled service from a group of sub-categories consisting of dietary, dressing and grooming, bathing and personal hygiene, toileting and continence, mobility and transfer, self administration of medicines, medically related household tasks, clean bathroom, change/make beds, clean appliances, dishes, kitchen surfaces, meal preparation/cleanup, laundry, dusting, tidy, floors—sweep/mop, floors—vacuum, empty trash, shopping/errands, ironing, mending, correspondence, wash inside windows and blinds, ostomy hygiene, catheter hygiene, bowel program, prescription ointment, aseptic dressing, non-injectable meds, passive range of motion, transfer/lift, R2—hourly, RS—block, R3—advanced (hourly), R4—advanced (block), R5—advanced (daily), R6—nurse respite, one-the-job training, supervisory visit, fill insulin syringes, oral medicine setup, monitor skin condition, diabetic nail care, evaluate advanced personal care plan, train apc, and other. Scheduling 204 the service may also include scheduling 214 a duration of time to be spent with the person for each scheduled service. Once scheduling is complete, a schedule for each worker is downloaded 216 to the portable electronic device 22 for use by the worker that will be providing the scheduled service(s). By automatically scheduling services to be provided over a period of time using the processor 24, manual scheduling may be unnecessary and therefore scheduling may require less employees and time spent, thereby decreasing costs expended by the entity. Additionally, by downloading the schedule to the portable electronic device 22, paper calendars may be unnecessary.

The worker will then execute the schedule by providing the scheduled service(s). To ensure that any person receiving a service does not receive more than the allotted number of hours for a particular category and/or sub-category of service, the method 200 may include tracking 218 a duration of time spent with the patient over a period of time (e.g., a month) for the particular category and/or sub-category of service using at least one of the portable electronic device 22 and the processor 24, and warning 220 when the duration of time spent with the patient exceeds a predetermined percentage of the duration of time to be spent with the person using at least one of the device 22 and the processor 24.

Before, during, and/or after a service has been provided, the method 200 includes storing 222 service information as electronic data within the portable electronic device 22 (FIG. 1) for each service provided by the worker. The service information may be any information relating to the service provided. In one embodiment, the service information includes at least one of a description of the service, a duration of the service, and a date of the service. Additionally, the service information may include an identifier corresponding to the person receiving the service. The identifier may be any identifier that corresponds to the person receiving the service (e.g., at least one of the first identifier and the second identifier discussed above). The service information may be entered into the portable electronic device 22 by the worker providing the service and/or the person receiving the service using the user interface 34 (FIG. 1). Alternatively, the service information may be selected from service information stored in the device 22 (e.g., selecting from service information displayed on display 30 (FIG. 1)) by the worker providing the service and/or the person receiving the service. In one embodiment, the method 200 includes displaying 224 an input screen on the display 30 of the portable electronic device 22 for entering the service information. By selecting/entering the service information using the device 22, mistakes and/or illegible entries may be greatly reduced, thereby possibly reducing an amount of time and cost expended by the provider of the service to double-check the service information.

At any time during or after the scheduled period of time, the service information for at least one service provided by the worker is uploaded 226 from the portable electronic device 22 to the processor 24 (FIG. 1). The processor 24 creates 228 an electronic file that is compliant with a government privacy standard and includes the service information for the service(s). The electronic file that is compliant with a government privacy standard may include service information for a plurality of services provided to a person over a period of time by a worker or a plurality of workers, and/or may include service information for at least one service provided to the person and at least one service provided to another person over a period of time. Medicaid is then billed 230 for the service by submitting the electronic file created by the processor 24 to Medicaid.

In an alternative embodiment, the service information is not uploaded 226 to the processor 24 but rather the portable electronic device 22 creates 228 the electronic file that is compliant with a government privacy standard and that includes the service information. The electronic file compliant with a government privacy standard may be submitted to the Medicaid for billing in any suitable manner, for example by mailing, shipping, and/or delivering the electronic file to Medicaid. Alternatively, the electronic file compliant with a government privacy standard may be electronically submitted to the Medicaid, for example using a WAN (e.g., the Internet) and/or a LAN (e.g., an intranet). In such a case wherein the electronic file compliant with a government privacy standard is electronically submitted to the Medicaid, it may be submitted from the processor 24, the portable electronic device 22, or any other device having the file stored therein. In one embodiment, the electronic file compliant with a government standard is electronically submitted to Medicaid over the Internet to an internet site. For example, in one embodiment the internet site includes an official Medicaid billing website of a state or territory of the United States of America. By automatically generating the electronic file for billing, using the processor 24 (or alternatively the device 22), mistakes and/or illegible entries may be greatly reduced, and additionally manual billing may be unnecessary and therefore billing may require less employees and time spent, thereby decreasing costs expended by the entity.

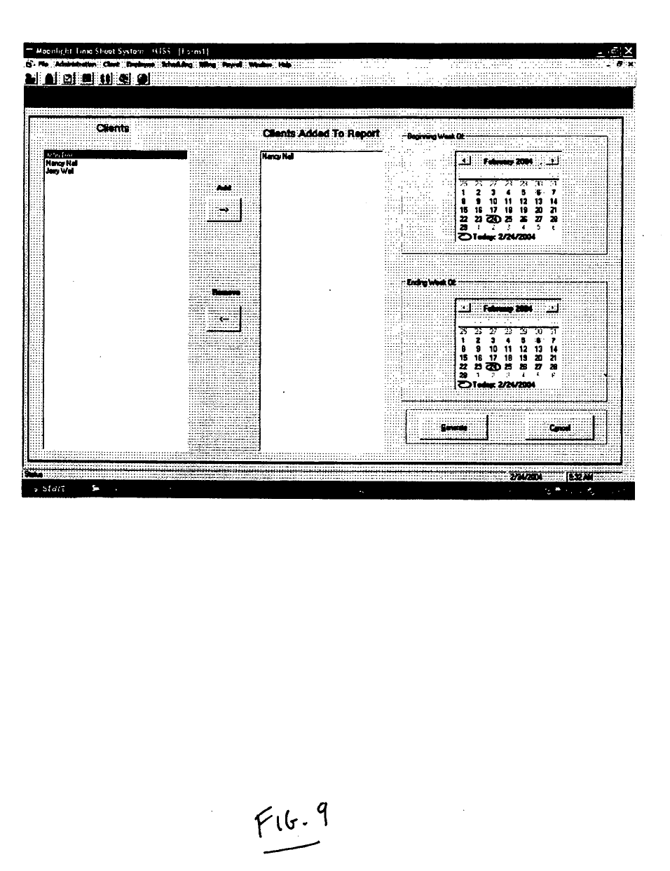

As discussed above, the service information may include at least one of a description of the service, a duration of the service, and a date of the service. Additionally, the service information may include an identifier corresponding to the person receiving the service (e.g., at least one of the first identifier and the second identifier discussed above). For the specific example of Medicaid, the device 22 may display a screen that resembles Medicaid Weekly Time Sheets for inputting/selecting the service information. (FIG. 9 illustrates an exemplary screen shot resembling the Medicaid Weekly Time Sheets for inputting/selecting the service information.) Service information for at least the specific example of Medicaid, and selectable/inputtable on such a screen as shown in FIG. 9, may include at least one description of the service selected from a group of categories consisting of basic personal care, advanced personal care, respite, advanced respite, homemaker chore, authorized nurse visits, adult day heath care, telephone reassurance, and other. Service information for at least the specific example of Medicaid, and selectable/inputtable on such a screen as shown in FIG. 9, may also include at least one sub-description of the service selected from a group of sub-categories consisting of dietary, dressing and grooming, bathing and personal hygiene, toileting and continence, mobility and transfer, self administration of medicines, medically related household tasks, clean bathroom, change/make beds, clean appliances, dishes, kitchen surfaces, meal preparation/cleanup, laundry, dusting, tidy, floors—sweep/mop, floors—vacuum, empty trash, shopping/errands, ironing, mending, correspondence, wash inside windows and blinds, ostomy hygiene, catheter hygiene, bowel program, prescription ointment, aseptic dressing, non-injectable meds, passive range of motion, transfer/lift, R2—hourly, RS—block, R3—advanced (hourly), R4—advanced (block), R5—advanced (daily), R6—nurse respite, one-the-job training, supervisory visit, fill insulin syringes, oral medicine setup, monitor skin condition, diabetic nail care, evaluate advanced personal care plan, train apc, and other.

The service information selectable/inputtable on such a screen as shown in FIG. 9 may also include both the first indentifier and the second identifier associated with the beginning and ending times of service, respectively, for the same purposes as that discussed above with regard to FIGS. 1-3. Additionally, as discussed above Medicaid sometimes randomly audits the Weekly Time Sheets and may require the in-home service provider keep the Time Sheets on file for up to 5 years. Accordingly, the method 150 may also include storing 232 the service information for a period of time. The service information may be stored 232 by the portable electronic device 22 and/or may be stored 232 by the processor 24 (e.g. using the memory 34) after being uploaded from the device 22 to the processor 24. Additionally, the service information may be stored in a format that resembles (at least when displayed and/or retrieved) the Medicaid Weekly Time Sheets. In one embodiment, the service information is stored 232 for at least five years. If Medicaid desires to audit the service information, the method 200 may also include retrieving 234 the service information from the device 22 and/or the processor 24 for the audit. Because the service information is stored electronically in the processor 24 and/or the portable electronic device 22, a large amount of storage space is not necessary to store paper copies of the Medicaid Weekly Time Sheets.

The method 200 may also include electronically generating 236 payroll information using the service information. In one embodiment, payroll information for a period of time (e.g., a particular pay period) is electronically generated using service information for a plurality of services provided to the person over a period of time, and/or using service information for at least one service provided to the person and at least one service provided to another person over a period of time. Accordingly, payroll information can be generated for each worker on the basis of the service(s) provided to a particular person, and/or payroll information can be generated for each worker on the basis of the services provided by a particular worker to one or a plurality of persons over a period of time. By automatically generating payroll information using the service information and at least one of the processor 24 and the device 22, manual generation of payroll information may be unnecessary and therefore may require less employees and time spent, thereby decreasing costs expended by the entity. Additionally, by downloading the schedule to the portable electronic device 22, paper calendars may be unnecessary.

### EXAMPLE 1

### The Moonlight Time Sheet System for Medicaid In Home Service Providers

A Solution

The inventor has developed the Moonlight Time Sheet System™ (“MTSS”). The MTSS is a paperless solution system that: (i) when loaded onto personal digital assistants (PDA) automates the paper-record keeping requirements that Medicaid home healthcare provider aides have to use several times daily through the use of multiple “check the box” screens on their PDAs; and (ii) when accessed on a system-wide basis on the Medicaid home healthcare provider's standard computer system using their internet connection, it collects the digital data downloaded by the aides daily and transmits it in appropriate format to the Division of Medical Services—Medicaid, thereby substantially reducing the administrative and operating costs for the In-Home Service agency, increasing record-keeping compliance and privacy, and increasing profit margins significantly.

A focus of the MTSS is to significantly reduce the paperwork in the Medicaid home healthcare industry by combining a web application including an employee/client database, scheduling system, payroll generator, batch billing and data storage application with a remote data collection application. The MTSS consists of a PDA (Personal Digital Assistant) based software application that is tied in with an internet web application. The MTSS includes the new procedure codes that went into effect on Oct. 1, 2003. The MTSS process conforms to HIPAA (Health Insurance Portability and Accountability Act) standards. The billing portion of the software component is HIPAA compliant.

The inventor developed a PDA application that will hot sync with an internet web application to eliminate the errors created from the paper based process. The hot sync can be done at the provider's office or remotely by using an external modem with the PDA. The Moonlight Time Sheet System™ will eliminate much paperwork, lower operating costs, and make Medicaid home healthcare audits a much smoother process. The target customers and their staffs for the MTSS will readily recognize the interface that they see on the PDAs and on the web applications. The inventor successfully built the system so that the familiarity and knowledge of the industry's paper forms will make for a smoother implementation of the software.

Once Medicaid faxes the LTACS and the DA3A the Provider will be able to enter and save the patient's information digitally into the MTSS. With the Provider's patients and employees entered into the system the Provider will then be able to schedule “by patient” or “by employee”. The MTSS keeps track of the assigned number of hours for the month of each main category of service per patient. Under the assigned hours of each service there is a record of scheduled hours to assure the Provider will not “over service” creating non-reimbursement of services. The scheduling module has functions that make it easier to pair an employee with a patient. In the In-Home Service industry, it is essential to pair up the patient with an employee that is adequately trained in servicing a patient with the patient's ailments.

Once the Provider schedules the caregivers to the patients or the caregivers schedule has been updated they will hot sync each PDA with the MTSS (this will take an average of 30 seconds). The MTSS will populate the PDA with the real time monthly schedule of the caregiver. The caregiver will now be able to collect the necessary data to fill out the Medicaid Weekly Time Sheet.

It is envisioned that the caregivers will hot sync every morning to send the already collected time sheet information to the provider's office and to access their updated schedule for the day. The hot sync will populate the MTSS for storage and retrieval of Medicaid Weekly Time Sheets for auditing. That same hot sync will populate the PDA with the caregiver's new schedule. The time sheet data from the hot sync will also be used to bill Medicaid using Missouri Medicaid's billing website, www.emomed.com or each states related electronic billing site. The MTSS will create a HIPAA (Health Insurance Portability and Accountability Act) compliant file that can be uploaded on Missouri Medicaid's website for batch billing. The MTSS will also generate a payroll spreadsheet for that particular pay period. Also, all past data that was collected by caregivers can be generated in a digital form that resembles the Medicaid Weekly Time Sheet. Since the MTSS is a web application, all of the data may be stored on servers.

Medicaid could also utilize the MTSS on a system-wide basis, which is a market the Company intends to explore in the future once its business operations have been established. The PDA application may be enhanced to carry a time and date stamp that correlates with the signature of the patient. The patient could “sign in” the caregiver as they arrive to the home and “sign out” at the time of departure. As the patient signed, a permanent, unchangeable time and date stamp would be administered. This would help prevent against a common problem in Medicaid known as “upcoding”. Upcoding is when a caregiver reports a longer duration of time spent on a particular category or subcategory of care than was actually administered.

Background to Medicaid In Home Service

Medicaid allows only certain types of care from In-Home Service Providers. There are six categories of care, Personal Care, Homemaker, Chore, Advanced Personal Care, Nurse, and Respite. Under each main category there are numerous sub-categories of care. For instance, a patient could be awarded 20 hours per month of Personal Care and 10 hours of Homemaker. There are 7 sub-categories of care under Personal care and 15 sub-categories under Homemaker. A list of all of the categories and sub-categories can be found on the DA3A (which is herein incorporated by reference). If, for any reason, the caregiver goes over the allotted hours, the provider must pay the caregiver for every hour he/she went over the Medicaid cap. The provider, however, does not get reimbursed from Medicaid, which is described as “over servicing” in the industry.

When, for example, Missouri Medicaid awards service to a patient, two documents are faxed to the In-Home Service Provider. The first form is called the Long Term Alternative Care System form (LTACS). The LTACS documents information concerning the patient, including what category/categories of care they are awarded and how many hours per month of each they will receive. The second form is the Service Plan Supplement or the DA3A. The DA3A states what sub-categories of service should be administered to/for the patient. Once the LTACS and the DA3A are faxed to the Provider, the Provider must schedule a caregiver to see the patient.

Scheduling can be a difficult part of the process. Some Providers in the state have up to 6 people, each with an average annual salary of $20,000-$23,000, performing the scheduling in one office. A paper calendar for each patient states which main categories of service are needed on each day for the month. Under these main categories, the calendar also lists the number of hours to be spent with the patient. This scheduling takes many hours. Once completed, the caregiver heads out into the field with the paper calendar of each patient they have, the DA3A of each patient, and a stack of Medicaid Weekly Time Sheets.

When in the field visiting patients, the caregiver documents information onto a paper-based Medicaid Weekly Time Sheet. This Weekly Time Sheet must include a description of the type of services administered, how long each service took, the date the service was administered, and the patient's signature on each day for the entire week. If a form is completed incorrectly, the caregiver must return to the patient's residence, and have them sign the Weekly Time Sheet again.

Medicaid randomly audits the Medicaid Weekly Time Sheets. If one form is not filed and/or filled out correctly, the Provider can be automatically fined tens of thousands of dollars. The Weekly Time Sheets must be kept on file for up to 5 years, creating large amounts of physical data storage. The handwritten form has a large potential for error because mistakes are common in this type of data collection. Once the document is turned in, the Billing Department must go through each one vigorously to make sure there are no mistakes and all the necessary signatures are present.

After all of the forms are checked for errors, they must be analyzed for payroll. The Weekly Time Sheets are also used in determining how many hours each caregiver will receive on his/her paycheck. Processing payroll in the paper-based process takes many work hours depending on the size of the provider.

Once payroll is completed using the Weekly Time Sheets, a full time employee who enters all the data must process them for billing. This data is entered either on a website provided by Missouri Medicaid or on software that they have purchased to batch bill Missouri Medicaid. Either method usually takes at least one full time employee, depending on the size of the provider. Other providers sometimes hire contractors to do their bill processing/data entry. The charge for this service averages 6% of Medicaid's reimbursement for the month billed. This charge includes only the data entry of the Weekly Time Sheet information. The above processes must be completed first.

Medicaid is the largest insurance provider in the United States. It is funded by the state in which the patient/provider resides and the federal government. Medicaid is also the primary source of health care for low-income families and elderly and disabled people. For fiscal year 2003, Missouri Medicaid paid claims of $308 million for the In-Home Service Industry. Although the industry is growing because of the continued growth in the size of the Medicaid-eligible population, Medicaid has actually reduced the number of service hours awarded to patients due to budgetary constraints. This usually hurts Medicaid home healthcare providers' bottom line. Because of cuts in Medicaid funding and the rise in the cost of workers compensation insurance, Medicaid home healthcare providers operate on small profit margins. This current environment created a significant need for the inventor to invent the MTSS. Using the MTSS is envisioned to reduce the operating costs inherent in running an In-Home Service agency.

The MTSS includes the new universal health care industry procedure codes that HIPAA mandated, which went into effect on Oct. 1, 2003. Procedure codes are the billing codes used in the healthcare industry to describe all of the different procedures caregivers, physicians, nurses and others perform on patients receiving medical care, whether the records are maintained digitally or in a paper-based format.

In addition, the federal government, when enacting HIPAA, also mandated that government-based health insurance programs such as Medicaid shift from either paper-based or a variety of incompatible electronic billing formats to a universal, standardized, digital billing process. The original implementation date for this mandate was to be Apr. 16, 2003, which was delayed until Oct. 16, 2003. (As of May 2004, the implementation date has been delayed yet again).

The HIPAA billing procedure mandate has directly or indirectly led, for example, to the Missouri Medicaid program establishing its website and encouraging all In-Home Service providers to bill electronically in the past few years by providing quicker reimbursement than if paper-based billing records are used. (The MTSS is designed to automate this electronic billing process even further through its batch billing function). Every major third party or private health insurance company in the U.S. also has incorporated both the universal procedure codes and the digital billing process in their operations.

Another significant area of utility for the MTSS is enabling home health-care providers, whether In-Home Service providers or not, to utilize an automated billing process with Medicare and third-party private insurance companies.

State of the Art of Medicaid Service Information Management and Reporting

As of the date of filing the instant application, the inventor is not aware of any technology-based product commercially available in the market for In-Home Service Providers, especially in Missouri, to use to automate their Medicaid billing by collecting data remotely using a PDA.

Currently, commercial companies are available to contract persons to do the billing for the In-Home Service provider. This service can cost the provider from a few dollars per billing sheet to 6% or more of what the contractor bills Medicaid. This service, however, only includes the basic data entry of the Medicaid Weekly Time Sheet information and patient information into either the Missouri Medicaid website or through batch billing software. It does not include analyzing the forms for errors in categorization of service, or payroll processing, which are time-consuming tasks, and extremely important to perform. Such contract work, therefore, is not truly comparable to the MTSS.

In-Home Service Providers are also able to use a telephone-based electronic billing system once they have acquired all of the necessary technology and undergone extensive training. The telephony system is offered by Carekeepers in Atlanta and Shepherds in St. Louis, along with a few other companies. The system utilizes the touch-tone features of the home phone in the patient's residence. Once the caregiver gets to the residence, he/she must use the patient's phone and call a number. By calling the number, the system tracks the time the caregiver arrived and started service on the patient. Once service is completed, the caregiver uses the phone again and touch-tones the necessary keys on the phone to electronically record what services were rendered.

Only a few providers use the telephony system. The lack of interest in the telephony system is due, the inventor believes, to a couple of factors. One factor is the cost. The initial costs for the license fee, software, training, phone set-up, and implementation range from $10,000 to $70,000 plus. There is also a $0.25 charge on average for each call made from the patient's house that is charged to the provider. Two calls are made per visit by the caregiver, once upon arrival and the second when leaving, which means the average cost of the telephony system is $0.50 per visit.

Another negative factor of the telephony system is the time tracking feature. A majority of Medicaid covered In-Home care is provided in 15-minute units. Missouri Medicaid will not allow a caregiver or In-Home Service Provider to round up to the next quarter-hour increment when billing using the telephony system. If, therefore, a caregiver was at a patient's home for 1 hour and 12 minutes when the second, exit telephone call is made, the provider does not get reimbursed for the last 15-minute unit, and is only paid for 1 hour of service. (Many providers will also not compensate the caregiver if the time cannot be billed through to Medicaid). Although an aberration of the Medicaid billing process, since there is no such penalty under a paper-based or PDA-based system, this negative feature of the telephony system can drastically affect the reimbursement rate/employee payout of the provider.

Patients also have complained of the caregivers using their phones. Furthermore, problems with the telephony system could arise when the patient's home phone was already in use by someone else, out of service, rotary-based, or non-existent.

Although some portions of the present invention are herein described and illustrated in association with providing a medical insurance-based service, and more specifically, in association with providing a service under Medicaid, it should be understood that the present invention is generally applicable to the provision of any service. Accordingly, practice of the present invention is not limited to providing a medical insurance-based service, nor is practice of the present invention limited to providing a service under Medicaid.

Exemplary embodiments of systems and methods for providing a service to a person are described above in detail. The methods and systems are not limited to the specific embodiments described herein, but rather, components of each system may be utilized independently and separately from other components described herein. Additionally, steps of each method may be utilized independently and separately from other steps described herein. Each system component can also be used in combination with other components, and each method step can also be used in combination with other method steps.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

1-42. (canceled)

43. A method for providing a service to a person, said method comprising:
storing service information as electronic data within a portable device, wherein the service information comprises at least one of a description of the service, a duration of the service, and a date of the service;
uploading the service information from the portable electronic device to a processor;
creating an electronic file compliant with a government privacy standard and comprising the service information using the processor; and
billing an entity for the service by submitting the electronic file created by the processor to the entity.

44. A method in accordance with claim 43 wherein the government privacy standard comprises the Health Insurance Portability and Accountability Act.

45. A method in accordance with claim 43 wherein said creating an electronic file compliant with a government privacy standard comprises creating an electronic file compliant with the National Electronic Data Interchange Transaction Set Implementation Guide for ANSI ASC X34N 859 Health Care claims.

46. A method in accordance with claim 43 wherein the entity comprises a medical insurance-based entity.

47. A method in accordance with claim 46 wherein the entity comprises Medicaid.

48. A method in accordance with claim 43 further comprising retrieving from the person an identifier corresponding to the person.

49. A method in accordance with claim 48 wherein said retrieving from the person an identifier comprises retrieving the identifier using the portable electronic device, and wherein the service information further comprises the identifier.

50. A method in accordance with claim 43 wherein the identifier is selected from a group of identifiers consisting of a signature, a fingerprint, eye image data, a voice print, a facial pattern, and a hand measurement.

51. A method in accordance with claim 43 wherein said storing service information as electronic data comprises selecting at least one description of the service from a group of descriptions consisting of basic personal care, advanced personal care, respite, advanced respite, homemaker chore, authorized nurse visits, adult day heath care, and telephone reassurance.

52. A method in accordance with claim 51 wherein said selecting at least one description of the service comprises selecting at least one sub-description of the service from a group of sub-descriptions consisting of dietary, dressing and grooming, bathing and personal hygiene, toileting and continence, mobility and transfer, self administration of medicines, medically related household tasks, clean bathroom, change/make beds, clean appliances, dishes, kitchen surfaces, meal preparation/cleanup, laundry, dusting, tidy, floors—sweep/mop, floors—vacuum, empty trash, shopping/errands, ironing, mending, correspondence, wash inside windows and blinds, ostomy hygiene, catheter hygiene, bowel program, prescription ointment, aseptic dressing, non-injectable meds, passive range of motion, transfer/lift, R2—hourly, RS—block, R3—advanced (hourly), R4—advanced (block), R5—advanced (daily), R6—nurse respite, one-the-job training, supervisory visit, fill insulin syringes, oral medicine setup, monitor skin condition, diabetic nail care, evaluate advanced personal care plan, and train apc.

53. A method in accordance with claim 43 wherein said billing an entity for the service by submitting the electronic file created by the processor to the entity comprises electronically submitting the electronic file to the entity.

54. A method in accordance with claim 53 wherein said electronically submitting the electronic file to the entity comprises submitting the electronic file to the entity over the internet to an internet site.

55. A method in accordance with claim 54 wherein the internet site comprises an official Medicaid billing website of a state or territory of the United States of America.

56. A method in accordance with claim 43 wherein said billing an entity for the service by submitting the electronic file created by the processor to the entity comprises at least one of mailing, shipping, and delivering the electronic file to the entity.

57. A method in accordance with claim 43 further comprising:
retrieving from the person a first identifier corresponding to the person when the service begins using the portable electronic device;
recording a time when the first identifier is retrieved from the person using the portable electronic device;
storing the retrieved first identifier and the recorded time when the first identifier is retrieved as electronic data using the portable electronic device for verification of when service began;
retrieving from the person a second identifier corresponding to the person when provision of the service ends using the portable electronic device;
recording a time when the second identifier is retrieved from the person using the portable electronic device; and
storing the retrieved second identifier and the recorded time when the second identifier is retrieved as electronic data using the portable electronic device for verification of when provision of the service ended.

58. A method in accordance with claim 57 wherein the first and the second identifiers are selected from a group of identifiers consisting of a signature, a fingerprint, eye image data, a voice print, a facial pattern, and a hand measurement.

59. A method in accordance with claim 57 further comprising uploading the retrieved first identifier and the recorded time when the first identifier is retrieved from the portable electronic device to the processor.

60. A method in accordance with claim 57 further comprising uploading the retrieved second identifier and the recorded time when the second identifier is retrieved from the portable electronic device to the processor.

61. A method in accordance with claim 43 further comprising:
scheduling the service using the processor; and
downloading the schedule to the portable electronic device for use by a worker that will be providing the service.

62. A method in accordance with claim 61 wherein said scheduling the service comprises selecting at least one service from a group of services consisting of basic personal care, advanced personal care, respite, advanced respite, homemaker chore, authorized nurse visits, adult day heath care, and telephone reassurance.

63. A method in accordance with claim 62 wherein said selecting at least one service comprises selecting a sub-service from a group of sub-services consisting of dietary, dressing and grooming, bathing and personal hygiene, toileting and continence, mobility and transfer, self administration of medicines, medically related household tasks, clean bathroom, change/make beds, clean appliances, dishes, kitchen surfaces, meal preparation/cleanup, laundry, dusting, tidy, floors—sweep/mop, floors—vacuum, empty trash, shopping/errands, ironing, mending, correspondence, wash inside windows and blinds, ostomy hygiene, catheter hygiene, bowel program, prescription ointment, aseptic dressing, non-injectable meds, passive range of motion, transfer/lift, R2—hourly, RS—block, R3—advanced (hourly), R4—advanced (block), R5—advanced (daily), R6—nurse respite, one-the-job training, supervisory visit, fill insulin syringes, oral medicine setup, monitor skin condition, diabetic nail care, evaluate advanced personal care plan, and train apc.

64. A method in accordance with claim 61 wherein said scheduling the service comprises scheduling a duration of time to be spent with the person for the service.

65. A method in accordance 61 wherein said scheduling the service comprises scheduling a plurality of services to be provided to the person over a period of time.

66. A method in accordance with claim 65 further comprising scheduling a duration of time to be spent with the person for the plurality of services.

67. A method in accordance with claim 66 further comprising:
tracking a duration of time spent with the patient over at least a portion of the period of time using at least one of the portable electronic device and the processor; and
warning when the duration of time spent with the patient exceeds a predetermined percentage of the duration of time to be spent with the person.

68. A method in accordance with claim 61 wherein the person is a first person, and said scheduling the service comprises scheduling at least one service to be provided to the first person by a worker and at least one service to be provided to a second person by the worker.

69. A method in accordance with claim 43 wherein the processor includes a memory, said method further comprising storing the service information uploaded from the portable electronic device to the processor for a period of time using the memory.

70. A method in accordance with claim 69 wherein said storing the service information for a period of time using the memory comprises storing the service information for at least five years.

71. A method in accordance with claim 69 further comprising electronically retrieving the service information from the memory for an audit.

72. A method in accordance with claim 43 further comprising electronically generating payroll information using the service information.

73. A method in accordance with claim 43 further comprising:
displaying an input screen having inputs for the service information using the portable electronic device; and
entering the service information into the inputs for storage of the service information within the portable electronic device.
